(19) United States
(12) Patent Application Publication
(10) Pub. No.: US 2007/0026949 A1
(43) Pub. Date: Feb. 1, 2007

(54) Equipment for transporting chips and chip carrier structure therefor

(75) Inventors: Gerard Charlier, Paris (FR); Emmanuel Gelinotte, Savigny Les Beaune (FR)

Correspondence Address: GREENBLUM & BERNSTEIN, P.L.C., 1950 ROLAND CLARKE PLACE, RESTON, VA, 20191, US

(73) Assignee: GAMING PARTNERS INTERNATIONAL, Savigny Les Beaune (FR)

(21) Appl. No.: 10/547,501

(22) PCT Filed: Jul. 28, 2005
(86) PCT No.: PCT/FR05/01973

§ 371 Date: Dec. 9, 2005

(51) Int. Cl. G06F 17/00

(52) U.S. Cl. 463/47

(57) ABSTRACT

The equipment for transporting chips carrying coded information includes a movable structure carrying chips with an electronic circuit arranged in columns in stacked racks and a docking station for the carrier structure in the place of storage of the chips, for example the vault of the casino, or at their place of use, for example a gaming table. The carrier structure includes a plane base divided by a partition with a handle for carrying two stacks of racks of chips and a lid. The docking station integrates part of an RFID contactless radio-frequency reading station for reading the coded information carried by the chips of at least one column to determine or verify the content of at least one batch of chips present in the carrier structure, in particular to draw up or to check an inventory thereof. The read station includes a read unit with a digital section and an analog section provided with a wide-loop antenna with three loops respectively integrated into the walls of the lid and the median partition fixed to the plane base.

### CROSS REFERENCE TO RELATED APPLICATIONS

The present application is a U.S. National Stage of International Patent Application No. PCT/FR2005/001973 filed Jul. 28, 2005.

### BACKGROUND OF THE INVENTION

1. Field of the Invention

The present invention relates to equipment for transporting chips carrying information, in particular gaming chips for casinos and gaming rooms. The invention is applicable to moving gaming chips from a place of storage of gaming chips, for example a vault, to a place of use of the gaming chips, for example a gaming table.

2. Discussion of Background Information

The expression “gaming chip” or “casino chip” means a disk or plate representing a face or other value. Chips are generally fabricated from scratch-resistant rigid plastics material and feature varied patterns in terms of design and color to form a more or less complex decoration and to reduce the risk of fraudulent reproduction and/or falsification.

To facilitate the management and tracing of chips, and to reduce further the risk of fraud, certain chips carry coded information. There is integrated into the body of the chip an electronic circuit with a memory for storing information relating to the chip, in particular its identification code or number and its numerical value. Chips equipped with an electronic circuit with a memory are known as “electronic memory chips” or “electronic circuit chips”. Depending on the chip design, the electronic circuit is of the PROM or EEPROM type or may even take the form of a microprocessor associated with a memory. Other chips carry coded information, in particular for optical reading, for example a bar code or color code marked on the faces and/or the edge of the chip (edge marking saves time by direct reading of stacked chips); it should be noted that coding chips for RFID reading and for optical reading are not mutually exclusive.

Chips are often stored in trays or racks that conventionally serve as local reserves of chips at the money changing desks and/or gaming tables. A rack contains chips exchanged for cash, for example, or for chips of different face value, etc. It is also possible to take from a rack the chips necessary to pay a winning play and to place in a rack chips of losing plays. The number of chips in a rack changes and consequently the overall value of the chips in the rack varies.

To facilitate tracking the chip content of the rack and in/out movements of chips, in order to monitor such movements more closely and thereby to combat fraud more effectively, commonly owned International Publication No. WO 97/30414 has proposed providing the rack with chip storage columns and with reading and/or writing devices able to communicate with the chips stored in the columns. The reading device includes ferrite antennas at the top of the columns or slanted loop antennas under the columns. By using anti-collision algorithms, the communication unit is able to read/write all the chips of one or more stacks of 20 chips.

However, racks of the above kind are limited by relatively small capacities (generally 100 chips maximum, consisting of five columns or stacks each of 20 chips). Moreover, these racks with combined chip reading stations designed for localized use of chips with an electronic circuit with a memory are not suitable for secure transportation, even within a closed enclosure in a casino or gaming room of larger batches of chips, for example batches from 800 to 1200 chips.

There is therefore a need for equipment for transporting chips carrying coded information, in particular gaming chips between a place of storage and one or more places of use that avoids the need for counting and/or manual verification before and after transporting large batches of chips.

### SUMMARY OF THE INVENTION

The invention proposes equipment for transporting chips carrying coded information, in particular gaming chips between a place of storage and at least one place of use. The equipment includes a movable structure for carrying chips arranged in columns or stacks and at least one first docking station for the carrier structure in the place of storage. The docking station integrates all or part of at least one station for reading the coded information carried by the chips of at least one column or stack to determine or verify the content of at least one batch of chips present in the carrier structure, in particular to draw up or to check an inventory thereof. The docking station is advantageously adapted to determine or verify the content of at least one batch of chips present in the carrier structure, in particular to draw up or to check an inventory thereof.

According to the invention, the chip transport equipment includes in the place of use a second docking station for the carrier structure identical to or compatible with the first docking station. It is therefore possible to verify the chip content of the carrier structure when it reaches the place of use of the chips, for example a gaming table.

The chip transport equipment is adapted to transport operations when the place of storage is defined by a secure central store for gaming chips or a vault of a casino or gaming room or by a teller counter of a casino or gaming room. The place of use may be defined by a change or gaming table of a casino or gaming room.

According to the invention, the carrier structure takes the form of a closed and optionally lockable enclosure.

The invention uses the carrier structure, which is itself portable, for the secure transport of large quantities of chips within a gaming room or a casino without having to provide the racks carried by the carrier structure with reading devices. In practice, the amount of chips carried is appropriate to the load that a casino croupier can carry, including the combination of the carrier structure and the chips, which are usually placed beforehand in simple plastics material racks. This can be, for example, around ten racks of chips.

In a preferred embodiment of the invention, the chip transport equipment includes a carrier structure that has a plane base adapted to receive at least one rack of chips in parallel columns. The carrier structure is adapted to receive at least one plurality of stacked removable racks of chips in parallel columns. The carrier structure is adapted to receive two stacks of chip racks disposed one on each side of a separating partition fastened to the plane base and provided with a holding device for the croupier transporting the carrier structure. To facilitate loading and unloading chip racks, the carrier structure includes a removable lid disposed on the plane base and adapted to enclose the rack or racks and the chips they contain. Thus, the carrier structure is arranged, while remaining transportable by a croupier, to provide a secure transport capacity for up to 800 to 1200 chips, which is much greater than the rack described in WO 97/30414.

The chip transport equipment of the invention advantageously includes at least one read station adapted to read coded information on or in each chip in the same column or stack of chips, in particular information identifying the chip and/or information regarding the face value of the chip.

According to a first way of reading chips (optical reading) used in the chip transport equipment of the invention, the at least one read station includes a video camera or cameras oriented to read coded information on the edge of chips stored in columns or stacks.

According to another way of reading chips (contactless RFID reading) used in the chip transport equipment of the invention, the at least one read station includes RFID contactless radio-frequency reception adapted to read coded information in a memory of a chip with an electronic circuit. The at least one read station advantageously includes a read or read/write unit including an analog section with one or more antennas and a digital processing section with a microprocessor.

In an embodiment of the invention with an RFID reading station, the invention may include at least one wide-loop antenna adapted to be disposed facing the tops of the columns and stacks of chips present in the carrier structure, the antenna being either totally integrated into the docking station or the carrier structure or divided between the docking station and the carrier structure. The wide-loop antenna advantageously includes a plurality of individual loops coaxial with one or more wire turns, the individual loops having substantially identical active areas and being electrically connected in series.

To enhance the reliability of the reading of chips contained in a carrier structure of large capacity (for example, with stacks comprising 5 or 6 racks of 100 chips), the RFID read station includes a plurality of adjacent wide-loop antennas each including a plurality of the coaxial individual loops connected to the read or read/write unit via a multiplexing device.

According to an embodiment of the invention with a carrier structure with a plane base referred to above, at least one wide-loop antenna individual loop is integrated into a wall of the lid of the carrier structure and electrically connected by contact to the docking station via the plane base in a series circuit with the other individual loops of the same antenna.

In another embodiment of the invention with a carrier structure with a plane base described above, at least one wide-loop antenna individual loop is integrated into the separator partition of the carrier structure and electrically connected by contact to the docking station via the plane base in a series circuit with the other individual loops of the same antenna.

According to the invention, the carrier structure integrates a read/write electronic circuit of the contactless RFID type with memory. This is referred to as the label circuit and is adapted to communicate, without contact, with the docking station and to store the identification of the carrier structure and/or the content and/or the inventory of at least one batch of chips or of all of the chips present in the carrier structure. The label circuit may be attached to an external face of the plane base of the carrier structure so as to be able to communicate with a docking station or a read or read/write station that is independent and portable or associated with a gaming, cash or change table or with a chip sorter or with any other casino or gaming room equipment.

The invention also relates to a chip carrier structure with integrated antenna(s) for gaming chip transport equipment of the invention defined hereinabove.

The invention also relates to a chip carrier structure with a label circuit for gaming chip transport equipment of the invention defined hereinabove.

According to the invention, there is provided equipment for transporting gaming chips carrying coded information between a place of storage and a place of use, including: a carrier structure which is structured and arranged for carrying chips arranged in columns or stacks; and at least one docking station including at least a part of at least one read station that reads the coded information carried by the chips of at least one column or stack to determine or verify a content of the chips of the at least one column or stack. The at least one docking station draws up or checks the inventory of the chips. The at least one docking station determines the presence of all of the chips in the carrier structure. The at least one docking station may include a first and second docking station, each including at least a part of at least one read station that reads the coded information carried by the chips of at least one column or stack to determine or verify a content of the chips of the at least one column or stack. The first docking station may be disposed in the place of storage and the second docking station disposed in the place of use.

The place of storage may include a secure central store for gaming chips. The secure central store may include at least one of a casino vault, a gaming room vault, a casino teller counter, and a gaming room teller counter. The place of use may include at least one of a casino change table, a gaming room change table, a casino gaming table, and a gaming room gaming table.

The carrier structure may include a closeable and lockable enclosure. The carrier structure may include a substantially planar base structured and arranged to receive at least one rack of the chips. The carrier structure may be structured and arranged to receive a plurality of stacked removable racks of the chips in parallel columns.

The equipment may include a partition fastened to the substantially planar base and a holding device provided on the partition, wherein the carrier structure is structured and arranged to receive first and second stacks of the removable racks, which are disposed on opposite sides of the partition. The equipment may include a lid removably positionable on the substantially planar base, and structured and arranged to enclose the at least one rack.

The at least one read station reads the coded information carried on or in each chip in a column or stack of chips. The coded information may include at least one of chip identification and chip face value. The at least one read station may include at least one of a video camera and a camera oriented to read the coded information on edges of the chips. The at least one read station may include a radio frequency identification (RFID) device having an electronic circuit structured and arranged to read the coded information from a memory of each chip in a column or stack. The at least one read station may include a read or read/write unit having an analog section including at least one antenna, and a digital processing section including a microprocessor.

The at least one antenna may include at least one wide-loop antenna arranged to face an end of the columns or stacks of the chips in the carrier structure, where the at least one wide-loop antenna is one of: totally integrated into the carrier structure, totally integrated into the at least one docking station, or divided between the carrier structure and the at least one docking station. The at least one wide-loop antenna may include a plurality of coaxial individual loops with one or more wire turns, in which the individual loops have substantially identical active areas, and are electrically connected in series. The at least one wide-loop antenna may include a plurality of the wide-loop antennas, and the equipment further includes a multiplexing device structured and arranged to connect a plurality of the individual loops of each of the plurality of wide-loop antennas to the read or read/write unit.

At least one wide-loop antenna loop may be integrated into a wall of a lid of the carrier structure, electrically connected to the at least one docking station through contacts in a substantially planar base, and connected in series with other individual loops of the at least one wide-loop antenna. At least one wide-loop antenna loop may be integrated into a partition of the carrier structure, electrically connected to the at least one docking station through contacts in a substantially planar base, and connected in series with other individual loops of the at least one wide-loop antenna.

A label circuit, including an RFID-type read/write electronic circuit with memory, may be integrated into the carrier structure for controlling communication with the at least one docking station, wherein the label circuit stores and communicates information including at least one of: identification of the carrier structure, contents of at least one batch of chips in the carrier structure, inventory of at least one batch of chips in the carrier structure, contents of all chips in the carrier structure, and inventory of all chips in the carrier structure. The label circuit may be attached to an external face of a substantially planar base of the carrier structure to communicate with the docking station or an independent and portable read or read/write station associated with at least one of a gaming table, a cash table, a change table, a chip sorter, casino equipment, and gaming room equipment.

The invention additionally provides a carrier structure for transporting gaming chips, including at least one wide-loop antenna integrated into the carrier structure and arranged to face tops of columns or stacks of chips in the carrier structure, wherein the at least one wide-loop antenna is structured and arranged to read coded information contained in an electronic memory circuit of each chip in the columns or stacks of chips, where the coded information comprises at least one of chip identification and chip face value.

Further according to the invention there is a carrier structure for transporting gaming chips, including a label circuit integrated with the carrier structure and including an RFID-type read/write electronic circuit with memory, wherein the label circuit is structured and arranged to communicate with at least one docking station, and to store and communicate information including at least one of: identification of the carrier structure, contents of at least one batch of chips in the carrier structure, inventory of at least one batch of chips in the carrier structure, contents of all chips in the carrier structure, and inventory of all chips in the carrier structure.

Even further according to the invention, there is provided equipment for transporting chips carrying coded information between a place of storage and a place of use, including: a carrier structure which is structured and arranged for carrying chips arranged in columns or stacks; and at least one docking station including at least a part of at least one read station that reads the coded information carried by the chips of at least one column or stack to determine or verify a content of the chips of the at least one column or stack. The at least one docking station draws up or checks the inventory of the chips. The at least one docking station determines the presence of all of the chips in the carrier structure. The at least one docking station may include a first and second docking station, each including at least a part of at least one read station that reads the coded information carried by the chips of at least one column or stack to determine or verify a content of the chips of the at least one column or stack, wherein the first docking station is disposed in the place of storage and the second docking station is disposed in the place of use.

### BRIEF DESCRIPTION OF THE DRAWINGS

Other objects, features and advantages of the present invention will become apparent on reading the following description with reference to the appended drawings of a preferred embodiment of the invention, provided by way of non-limiting example, in which drawings:

FIG. 1 is a diagrammatic perspective view of the chip carrier structure (shown open) used in an RFID type reading chip transport equipment of the invention;

FIG. 2 is a diagrammatic view partly in section in the plane XOY of an RFID type reading chip transport equipment of the invention including the type of carrier structure shown in FIG. 1, shown closed, and

FIG. 3 is a diagrammatic view partly in section (in the plane XOY) of a variant of the type of carrier structure shown in FIG. 2 with two wide-loop antennas.

### DETAILED DESCRIPTION OF THE PRESENT INVENTION

In the figures, which are not limiting on the invention, the various items are not necessarily represented to scale. Identical reference numbers are used in the various figures to designate identical or similar items. Dimensions are indicated by way of example only.

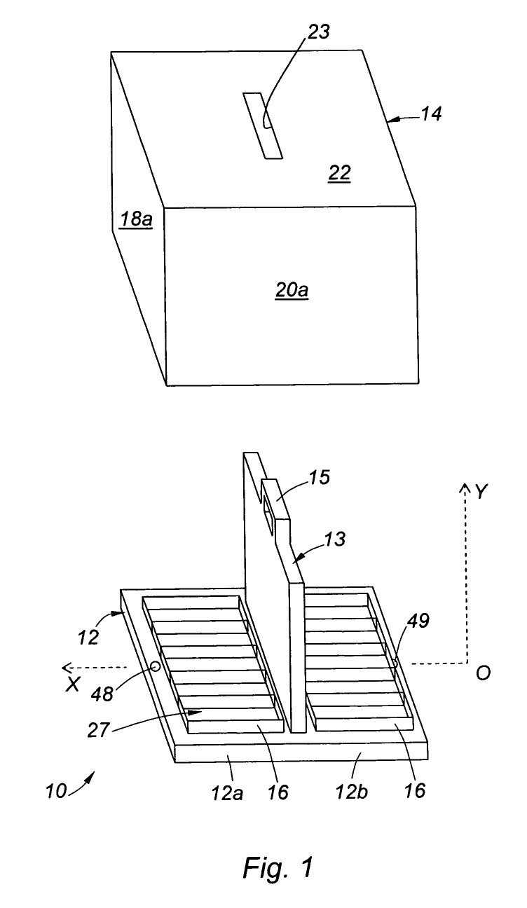

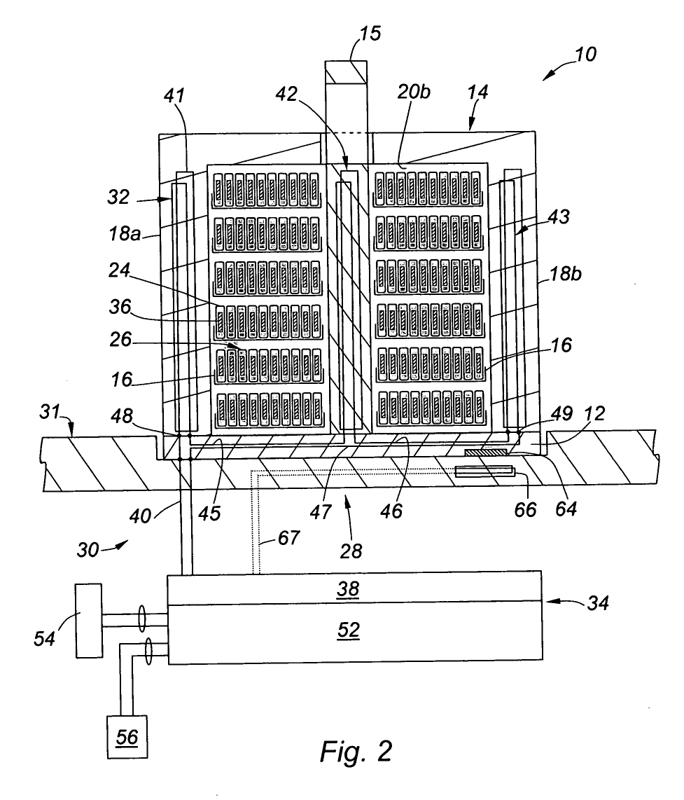

The gaming chip carrier structure 10 shown in FIG. 1 has a plane base 12 adapted normally to be disposed in a horizontal position and divided by a median plane vertical partition 13 firmly fixed in any appropriate way to the plane base 12. The upper edge of the partition 13 is provided with a holding device for the carrier structure, here a handle 15 in one piece with the partition. Each half-base 12a and 12b is adapted to accommodate racks 16 of gaming chips containing parallel columns of chips. By way of non-limiting example, the racks 16 are adapted to be stacked (see FIG. 2), are made from a rigid transparent plastics material, and have a capacity of 100 chips 24 (there are five parallel columns 26 each of 20 chips). The racks 16 are disposed to place the columns 26 of chips perpendicular to the plane of the partition 13 for reasons connected with reading the chips 24 that are described below. The racks 16 have separator walls to define therein sections 27 for storing chips (not shown in the figure) and having the general shape of a trough with a U-shaped bottom. This is known in the art. The storage sections may be column sections when they extend horizontally or quasi-horizontally, as is the case of the sections 27 of the carrier structure 10 described here (FIG. 2 shows columns 26 of ten chips 24 for convenience and to clarify the drawing, but it is understood that the columns can contain 20 chips 24), or stack sections when they extend vertically, as in the case of vertical dispenser racks (according to a different embodiment of the invention that is not shown).

The carrier structure also has a lid 14 shown open and removed from the plane base 12. The lid 14 has the general shape of a parallelepiped open at the bottom with four lateral faces 18a, 18b, 20a and 20b and an upper face 22. The upper face 22 has an opening 23 to allow the handle 15 to project through the lid 14 when the lid is covering the base 12 and the chip racks 16 stacked therein, such that the carrier structure is then closed, as shown in FIG. 2 (the lower edges of the lateral faces then bear on the top of the plane base 12). The carrier structure 10 thus defines a closed enclosure for the transported gaming chips, which optionally may be locked by any appropriate locking device (not shown). By way of non-limiting example, the carrier structure 10 is made from a non-metallic material, for example from rigid plastics material that is usually transparent in the case of the lid 14.

In addition to the carrier structure 10, the chip transport equipment includes at least one docking station 28 integrating in whole or in part a reading station 30 adapted to read coded information carried by the chips 26. FIG. 2 shows diagrammatically a docking station 28 of this kind situated, for example, on the table top 31 of a cash, change or gaming table or on a counter of a central chip store (for example a casino vault). Docking station 28 is shown equipped with the carrier structure 10 in the closed position, everything being shown partly in section in the median vertical plane XOY perpendicular to the partition 13.

The reading station 30 includes antenna 32, which may be associated with an antenna selection or multiplexing interface (not shown). Reading station 30 may include an electronic read/write unit 34 including a device for reading the memory of the chips and a device for writing the memory of the chips. The dialog electronic unit may comprise only a device for reading the chip memory, its structure and operation being similar to those described hereinafter in the case of the read/write unit 34.

The invention uses improved gaming chips including a “contactless” electronic identification device. Each chip 24 includes an electronic circuit 36 whereof the memory contains coded information specific to the chip to enable it to be identified and authenticated by an appropriate unit (a reading unit or a read/write unit operating in read mode). In the simplest version, the electronic circuits (not shown) of the chips are of the microcircuit type and equipped with a non-reprogrammable memory (for example of the PROM type) with a unique identification code on 32 bits or 64 bits generally comprising the serial number of the chip or the chip batch (its face value and other information concerning the chip such as the casino name, etc. may be stored in a database external to the chips, accessed by way of the serial number of the chip or the batch number). Whichever type of memory is used in the chip, the identification electronic circuit 36 of the chip further comprises a sender/receiver with a peripheral circular coil antenna that is also embedded in the chip and adapted to be energized by inductive coupling from the external antenna of the read station or the read/write station (in the present example this refers to the antenna 32 of the read/write station 30).

In another embodiment, the chip codes can be changed and the chips are equipped with reprogrammable memory (for example of the EEPROM type) that can be read and written. This ability to modify the information contained in the memory increases the security of the electronic chip by enabling the authentication parameters to be changed. Similarly, it is possible to customize certain areas of the memory and then to configure them reversibly or otherwise in a defined read-only or read/write memory area (the information concerning the chip stored in this way in its memory may include, by way of non-limiting example, in addition to the serial number of the chip or the batch number, the face value of the chip, the casino name, the fabrication number of the chip and its date of fabrication, etc.). In a further embodiment, the chip is equipped with a microprocessor able to carry out complex processing and transactions such as, for example, monitoring the dialog between the chip and the electronic read or read/write station, so that such dialog is authorized only after mutual authentication, involving the entry of password type codes and/or cryptography keys into the chip and the electronic unit (in particular for encrypting data during its transfer between the electronic unit and the chip).

The electronic circuit 36 of the chips 26 is adapted to allow simultaneous reading and/or writing of a plurality of chips or to discriminate between the chips, so that it can work on stacked gaming chips. The dialog unit integrating the discrimination function is adapted to capture the identity of a first chip in a batch of chips 24 situated in the radiated field of the antenna, for example a row of chips placed in a column 24 of a rack 16. It is then possible to dialog with this first chip and to perform the required read and/or write operations, and then to deactivate the chip by sending it a command to go to a standby state. The dialog unit continues its interrogations in search of other chips in the active area of the antenna to capture all the chips present in succession. After capturing and/or processing the last chip, the dialog unit sends a command to reactivate all of the chips in the column. This chip discrimination function is also known as an anti-collision function.

The structure and the mode of fabrication of the chips with an electronic circuit with memory are not described in detail here. By way of non-limiting example, commonly owned application EP-A-0694872 describes several types of chip structures usable in the context of the present invention.

Turning again to FIG. 2, the read station 34 for the chips 26 includes an analog section 38 with an antenna and a digital processing section 52 with a microprocessor. The analog section includes a single antenna 32 for reading chips 24 present in the carrier structure 10, the antenna 32 being of the wide-loop type (having an active area at least equal to several times the face surface area of a chip 24, whereof the diameter is substantially 40 mm to 50 mm) and including a plurality of individual coaxial loops of equivalent active area, connected electrically in series to define a single equivalent antenna. This refers to the three individual loops 41, 42 and 43, with one or more copper wire turns of approximately 0.5 mm diameter. The individual loops 41 and 43 are integrated into the lateral faces 18a and 18b and the individual loop 42 is integrated into the partition 13, the turns of generally circular or polygonal shape covering substantially all of the internal surface of the faces 18a and 18b and of the partition 13 in order to be able to read all the columns 26 of chips 24 present in the carrier structure 10 (the individual loops 41, 42 and 43 of the antenna 32 face the tops of the columns of chips stored in the racks 16). These copper wire turns, the electrical wire connections 45 and 46 between individual loops, and the wire line 47 are placed and glued into corresponding grooves or slots (not shown) in the faces 18a and 18b, the partition 13, and the plane base 12. To provide electrical continuity of the antenna 32 and connect it to the connection line 40 of the analog section 38, two pairs of electrical contacts 48, 49 are provided at the interface between the lid 14 (carrying the individual loops 41 and 43) and the upper face of the plane base 12. The electrical contacts 48, 49 may be, for example, of the metal leaf spring type (shown diagrammatically in FIG. 1 by small circles). A pair of electrical contacts is also provided at the interface between the lower face of the plane base 12 and the table top 31 of the docking station.

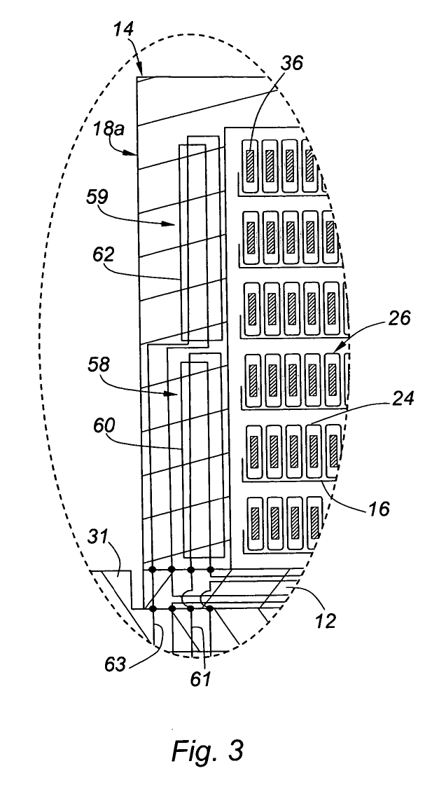

The “contactless” read/write unit 34 includes the analog section 38 and a digital processing section 52 which comprises a microprocessor that generates, interprets and processes signals exchanged with the electronic memory chips. The digital section 52 also controls an interface for sequentially selecting chip reading antenna(s) (not shown), for example of the multiplexing type when the unit 28 is used with a plurality of antennas (as shown in FIG. 3 and described hereinafter). It also includes an oscillator that generates the carrier frequency (for example 125 kHz) of the radio-frequency signal sent to the antennas, a time and date circuit capable of specifying the time and the date of each event, PROM for storing the processing sequences of the microcontroller, EEPROM for storing the processed data and exchanging data with the electronic chips, and an RS232/485 serial interface for connection to a server computer (not shown), either in point-to-point mode or in network mode. In particular, the digital section is able in read mode or in read/write mode to read and/or store and/or check the chip content of the carrier structure and to draw up or check an inventory thereof in bulk and in separate batches.

The digital section 52 is connected to input peripheral devices (for example a keyboard 54) and/or output peripheral devices (for example a visual display 56 and/or a printer and/or an audible warning device). The keyboard 54 is used, for example, to enter into the system information on the carrier structure 10 present on the docking station 28 or on the several sets of chips contained therein, the identity of the docking structure used, indications as to the intended transport, in particular the point of departure (for example the storage facility) and the destination (for example the place of use, such as a gaming, change or cash table), the identity of the operative loading or unloading the carrier structure, information on the corresponding accounting transaction, etc.

Similarly, the display (or printer) can display (or print) any or all of the following information specific to the inventory of the chip content of the carrier structure: the total number of chips present in the carrier structure, the number of chips per value and/or per batch, the overall value contained in the carrier structure, the transport indications, etc.

The analog section 38 includes an analog-to-digital converter (ADC), a modulator and an amplifier. On the basis of signals, commands, and information coming from the digital section 52, it generates an amplitude-modulated radio-frequency analog signal that conveys power, data and a synchronization signal to the electronic memory chips via the selected antenna. The electronic chips 24 are of the read or read/write passive type (with no internal energy store). The antenna 32 must therefore provide the energy necessary for the operation of the electronic circuit of the chip as well as transmit the data. The working distances between the antenna (individual loop) and the chips are defined as a function of the magnetic flux necessary for correct operation of the electronic circuit of the chip and therefore depend on the inductance, the geometry of the antenna and the antenna current. The faces of the chips 24 integrating the coils of the electronic circuits 36 are preferably parallel to the individual loops 41, 42, 43, 60 and 62 shown in FIGS. 2 and 3.

In some cases, and in particular in the case of carrier structures of large capacity, with five and six layers of stacked racks 16, to improve the reliability of reading the chips it is advantageous to provide a plurality of antennas in parallel and/or to facilitate the division into batches of the content of the carrier structure. By way of non-limiting example, FIG. 3 shows a variant of the FIG. 2 carrier structure in which the antenna 32 is replaced by two antennas 58 and 59 connected electrically in parallel, each having three individual loops of which only the loops 60 and 62 integrated into the face 18a of the lid 14 can be seen, the loops 60 and 62 being virtually back-to-back to cover the whole of the internal surface of the face 18a. In practice, as shown in FIG. 3, the loop 60 of the bottom antenna 58 covers the lower three levels of the stack of chip racks 16 and the loop 62 of the top antenna 59 covers the three upper levels of the stack of chip racks 16. Similarly, each antenna 58 and 59 is connected to the analog section 38 by a respective electrical connection line 61 and 63 and via appropriate electrical contacts in a similar manner to that described above with reference to FIG. 2 (the analog section 38 being provided with multiplexing antenna selection capability).

The carrier structure 10 may integrate a contactless read/write electronic circuit of the RFID type with memory, hereinafter referred to as the label circuit 64. Label circuit 64 is adapted to communicate without contact with the docking station (via a loop antenna 66 appropriately connected to the analog section 38 by the connecting line 67 shown in dashed line) and to store the identification of the carrier structure 10 and/or of the content and/or the inventory of at least one batch of chips or all of the chips present in the carrier structure 10. As shown in FIG. 2, the label circuit 64 is attached to the external face of the base plate 12 of the carrier structure 10 so that it is able to communicate with the docking station via the antenna 66 integrated into the tabletop 31 (the loop of the antenna 66 being perpendicular to the individual loops 41, 42, 43 of the antenna 32 to avoid any read or read/write interference between the label circuit and the chips 24). This arrangement of the label circuit 64 authorizes reading and/or reading/writing of the memory of the label circuit outside the docking station, for example by an independent read or read/write station that is either portable or associated with a gaming, cash or change table or with a chip sorter or with any other casino or gaming room equipment.

Without departing from the scope of the present invention, the shape, number, disposition and location of the antennas of the carrier structure and/or their individual loops and of the interface with the docking station may be changed as a function of fabrication constraints and/or diverse specifications indicated by casino operators. Similarly, it is possible within the context of the invention, to read/write the memory of the label circuit by way of a simple electrical connection.

The invention is not limited to chip transport equipment with a carrier structure integrating all the individual loops of wide-loop antennas. The antennas may be totally or partly integrated into the docking station, appropriately disposed in parallel planes in the case of a plurality of individual loops of the same antenna. For example, antennas may be disposed in parallel vertical panels (not shown) attached to the tabletop 31 and adjoining the faces 18a and 18b, with the individual loop integrated into the median partition 13.

Nor is the invention limited to chip transport equipment with a carrier structure and with removable racks that are stacked and/or have a median partition. For example, the carrier structure may have shelves for storing chips in parallel columns or stacks on a plurality of horizontal levels or in a plurality of vertical planes and one or more wide-loop antennas appropriately disposed or arranged to be able to read all of the chips contained in the carrier structure.

The invention is not limited to the geometrical shape of the carrier structure 10 described above, but rather encompasses other types of portable chip transport structures forming a closed enclosure and adapted to accommodate a large quantity of gaming chips in columns or stacks, possibly equipped with wide-loop RFID antennas, such as cases, briefcases, boxes, etc.

The invention is not limited to RFID reading of coded information carried by the chips. The coded information may be carried by the edge of the chips (for example in the form of a bar code or a color code) and is read by video cameras disposed at the docking station on either side of the carrier structure with transparent walls, the cameras being disposed to be able to read an entire column or stack at a time, and possibly slantwise relative to the column or stack. This type of equipment for reading chips optically may be equipped with an RFID reading label circuit analogous to the circuit 64 described above or with a label circuit read by way of an electrical connection.

1-23. (canceled)

24. Equipment for transporting gaming chips carrying coded information between a place of storage and a place of use, comprising:
a carrier structure which is structured and arranged for carrying chips arranged in columns or stacks; and
at least one docking station including at least a part of at least one read station that reads the coded information carried by the chips of at least one column or stack to determine or verify a content of the chips of the at least one column or stack.

25. The equipment of claim 24, wherein the at least one docking station draws up or checks the inventory of the chips.

26. The equipment of claim 25, wherein the at least one docking station determines the presence of all of the chips in the carrier structure.

27. The equipment of claim 24, wherein the at least one docking station comprises a first and second docking station, each including at least a part of at least one read station that reads the coded information carried by the chips of at least one column or stack to determine or verify a content of the chips of the at least one column or stack; and
wherein the first docking station is disposed in the place of storage and the second docking station is disposed in the place of use.

28. The equipment of claim 24, wherein the place of storage comprises a secure central store for gaming chips.

29. The equipment of claim 28, wherein the secure central store comprises at least one of a casino vault, a gaming room vault, a casino teller counter, and a gaming room teller counter.

30. The equipment of claim 24, wherein the place of use comprises at least one of a casino change table, a gaming room change table, a casino gaming table, and a gaming room gaming table.

31. The equipment of claim 24, wherein the carrier structure comprises a closeable and lockable enclosure.

32. The equipment of claim 24, wherein the carrier structure comprises a substantially planar base structured and arranged to receive at least one rack of said chips.

33. The equipment of claim 32, wherein the carrier structure is structured and arranged to receive a plurality of stacked removable racks of said chips in parallel columns.

34. The equipment of claim 33, further comprising:
a partition fastened to the substantially planar base; and
a holding device provided on the partition,
wherein the carrier structure is structured and arranged to receive first and second stacks of said removable racks, which are disposed on opposite sides of the partition.

35. The equipment of claim 32, further comprising:
a lid removably positionable on the substantially planar base, and structured and arranged to enclose the at least one rack.

36. The equipment of claim 24, wherein the at least one read station reads the coded information carried on or in each said chip in a column or stack of chips.

37. The equipment of claim 36, wherein the coded information comprises at least one of chip identification and chip face value.

38. The equipment of claim 36, wherein the at least one read station comprises at least one of a video camera and a camera oriented to read the coded information on edges of the chips.

39. The equipment of claim 36, wherein the at least one read station comprises a radio frequency identification (RFID) device having an electronic circuit structured and arranged to read the coded information from a memory of each chip in a column or stack.

40. The equipment of claim 39, wherein the at least one read station comprises a read or read/write unit comprising an analog section including at least one antenna, and a digital processing section including a microprocessor.

41. The equipment of claim 40, wherein the at least one antenna comprises at least one wide-loop antenna arranged to face an end of the columns or stacks of the chips in the carrier structure; and
the at least one wide-loop antenna is one of: totally integrated into the carrier structure, totally integrated into the at least one docking station, or divided between the carrier structure and the at least one docking station.

42. The equipment of claim 41, wherein the at least one wide-loop antenna comprises a plurality of coaxial individual loops with one or more wire turns, in which the individual loops have substantially identical active areas, and are electrically connected in series.

43. The equipment of claim 42, wherein the at least one wide-loop antenna comprises a plurality of said wide-loop antennas, and the equipment further includes a multiplexing device structured and arranged to connect a plurality of said individual loops of each of the plurality of wide-loop antennas to the read or read/write unit.

44. The equipment of claim 41, wherein at least one wide-loop antenna loop is integrated into a wall of a lid of the carrier structure, is electrically connected to the at least one docking station through contacts in a substantially planar base, and is connected in series with other individual loops of the at least one wide-loop antenna.

45. The equipment of claim 41, wherein at least one wide-loop antenna loop is integrated into a partition of the carrier structure, is electrically connected to the at least one docking station through contacts in a substantially planar base, and is connected in series with other individual loops of the at least one wide-loop antenna.

46. The equipment of claim 36, wherein a label circuit, comprising an RFID-type read/write electronic circuit with memory, is integrated into the carrier structure for controlling communication with the at least one docking station;
wherein the label circuit stores and communicates information including at least one of: identification of the carrier structure, contents of at least one batch of chips in the carrier structure, inventory of at least one batch of chips in the carrier structure, contents of all chips in the carrier structure, and inventory of all chips in the carrier structure.

47. The equipment of claim 46, wherein the label circuit is attached to an external face of a substantially planar base of the carrier structure to communicate with the docking station or an independent and portable read or read/write station associated with at least one of a gaming table, a cash table, a change table, a chip sorter, casino equipment, and gaming room equipment.

48. A carrier structure for transporting gaming chips, comprising:
at least one wide-loop antenna integrated into the carrier structure and arranged to face tops of columns or stacks of chips in the carrier structure,
wherein the at least one wide-loop antenna is structured and arranged to read coded information contained in an electronic memory circuit of each chip in the columns or stacks of chips, where the coded information comprises at least one of chip identification and chip face value.

49. A carrier structure for transporting gaming chips, comprising:
a label circuit integrated with the carrier structure and comprising an RFID-type read/write electronic circuit with memory,
wherein the label circuit is structured and arranged to communicate with at least one docking station, and to store and communicate information including at least one of: identification of the carrier structure, contents of at least one batch of chips in the carrier structure, inventory of at least one batch of chips in the carrier structure, contents of all chips in the carrier structure, and inventory of all chips in the carrier structure.

50. Equipment for transporting chips carrying coded information between a place of storage and a place of use, comprising:
a carrier structure which is structured and arranged for carrying chips arranged in columns or stacks; and
at least one docking station including at least a part of at least one read station that reads the coded information carried by the chips of at least one column or stack to determine or verify a content of the chips of the at least one column or stack.

51. The equipment of claim 50, wherein the at least one docking station draws up or checks the inventory of the chips.

52. The equipment of claim 51, wherein the at least one docking station determines the presence of all of the chips in the carrier structure.

53. The equipment of claim 50, wherein the at least one docking station comprises a first and second docking station, each including at least a part of at least one read station that reads the coded information carried by the chips of at least one column or stack to determine or verify a content of the chips of the at least one column or stack; and
wherein the first docking station is disposed in the place of storage and the second docking station is disposed in the place of use.
